(19) United States
(12) Patent Application Publication
(10) Pub. No.: US 2006/0078196 A1
(43) Pub. Date: Apr. 13, 2006

(54) Distributed apexes for 3-D ultrasound scan geometry

(75) Inventors: Thilaka S. Sumanaweera, Los Altos, CA (US); Anming H. Cai, San Jose, CA (US); Kutay F. Ustuner, Mountain View, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 10/965,494

(22) Filed: Oct. 13, 2004

(51) Int. Cl. G06K 9/00

(52) U.S. Cl. 382/154; 128/916

(57) ABSTRACT

Multiple apexes or intersections of scan lines are used to control the desired scan region for three dimensional scanning. Where a two dimensional transducer array is not square or circular or if the element spacing in azimuth and elevation is unequal, multiple apexes allow for optimization of the scanned volume to the transducer characteristics. The different apexes may be spaced from each other and relative to the transducer at various locations. Distributed patterns of apexes may be provided, such as spacing a plurality of apexes along a line in elevation and another set of apexes along a line in azimuth.

### BACKGROUND

The present invention relates to scan geometries for three dimensional imaging. In particular, scan geometries for more optimal fields of view are provided.

For two dimensional imaging, a plurality of scan geometries is available. FIGS. 1A through 1D show four scanned geometries. FIG. 1A shows a sector scan geometry. The origins of the scan lines 12 are all located at a single apex labeled A. The origins of the scan lines 12 correspond to the point at which a first sample is collected for each ultrasound line or the emitting and receiving surface of a transducer array. FIG. 1B shows a Vector® scan geometry. The origins of the scan lines are located along a straight line designated by XY. The straight line XY is located a distance away from the apex or intersection of the scan lines 12. FIG. 1C shows a curved-linear scan geometry. The origins of the scan lines 12 are located along the curved array XY. The scan lines 12 intersect at an apex. The circular arc of the XY origins corresponding to the curved transducer array has a center also located at the apex. FIG. 1D shows a curved-Vector® scan geometry. The origins of the scan lines 12 are located along a curved array surface labeled XY. The curvature of the array surface XY is centered at a location labeled C. The center C is different from the apex labeled A formed by the intersection of the scan lines 12. Another two-dimensional scan geometry is the linear format. The ultrasound lines are all parallel, resulting in no apex or an apex at an infinite distance behind the transducer surface.

Other two dimensional scan geometries use multiple apexes. For example, a sector scan geometry is split in half and the scan lines associated with each half are placed adjacent to two opposite sides of scan lines for a linear scan geometry. Scan lines may also be angled or steered during different scans of a same region for spatial compounding.

For three dimensional imaging, sector scan geometries are used. A two dimensional array transmits scan lines with origins at a single apex in the center of the transducer array for sector imaging. The scan lines are distributed in azimuthal and elevation dimensions throughout the volume to be scanned. Vector® imaging may also be provided where a single apex is positioned on the opposite side of the transducer array from the scanned region. The size and position of the scanned region corresponds to the size of the transducer. The ratio between the maximum field of view in azimuth and elevation is the same or substantially the same as the azimuth and elevation extent of the transducer.

### BRIEF SUMMARY

By way of introduction, the preferred embodiments described below include methods and systems for scanning a three dimensional volume. Multiple apexes or intersections of scan lines are used to control the desired scan region. Where a two dimensional transducer array is not square or circular or if the element spacing in azimuth and elevation is unequal, multiple apexes allow for optimization of the scanned volume to the transducer characteristics. The different apexes may be spaced from each other and relative to the transducer at various locations. Distributed patterns of apexes may be provided, such as spacing a plurality of apexes along a line in elevation and another set of apexes along a line in azimuth.

In a first aspect, a scan geometry is provided for three dimensional ultrasound for use with a two dimensional transducer array. The scan geometry includes a plurality of N scan lines distributed in a three dimensional volume. At most N−1 scan lines converge at a single apex.

In a second aspect, a system is provided for scanning a three dimensional volume. A beamformer is connectable with a multidimensional array of transducer elements. The beamformer is operable to form beams with ultrasound energy along a plurality of scan lines distributed within the three dimensional volume. Two or more subsets of the scan lines intersect at two or more locations, respectively, relative to the array.

In a third aspect, a method is provided for scanning a three dimensional volume with ultrasound energy. Ultrasound beams are formed along a plurality N of scan lines within the three dimensional volume with a multi dimensional transducer array for a single scan of the three dimensional volume. The N scan lines converge at different locations, and at most N−1 of the scan lines converge at a single location.

The present invention is defined by the following claims, and nothing in this section should be taken as limitation on those claims. Further aspects and advantages of the invention are discussed below in conjunction with the preferred embodiments, and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIGS. 1A through 1D are graphical representations of two dimensional scan geometries;

FIG. 2 is a block diagram of one embodiment of a system for scanning a three dimensional volume;

FIG. 3 is a graphical representation of the scan geometry for three dimensional imaging;

FIG. 4 is a graphical representation of another embodiment of a scan geometry for three dimensional imaging;

FIG. 5 is a graphical representation showing the relationship of various aspects of one embodiment of a scan geometry; and

FIG. 6 is a flow chart diagram of one embodiment of a method for scanning a three dimensional volume.

### DETAILED DESCRIPTION OF THE DRAWINGS AND PRESENTLY PREFERRED EMBODIMENTS

For scanning a three dimensional volume, a three dimensional scan geometry is provided. The scan geometry defines the location of various ultrasound scan lines within a three dimensional volume for acquiring data for imaging. The outer extent of the scan geometry corresponds to the scan lines and associated surfaces or regions interconnecting the outer scan lines. The scan geometry includes one or more apexes. An apex corresponds to an intersection of two or more scan lines. The apex geometry defines the orientation of the scan lines within the scan geometry. By providing a plurality of different apexes, a more optimal scan geometry may be provided.

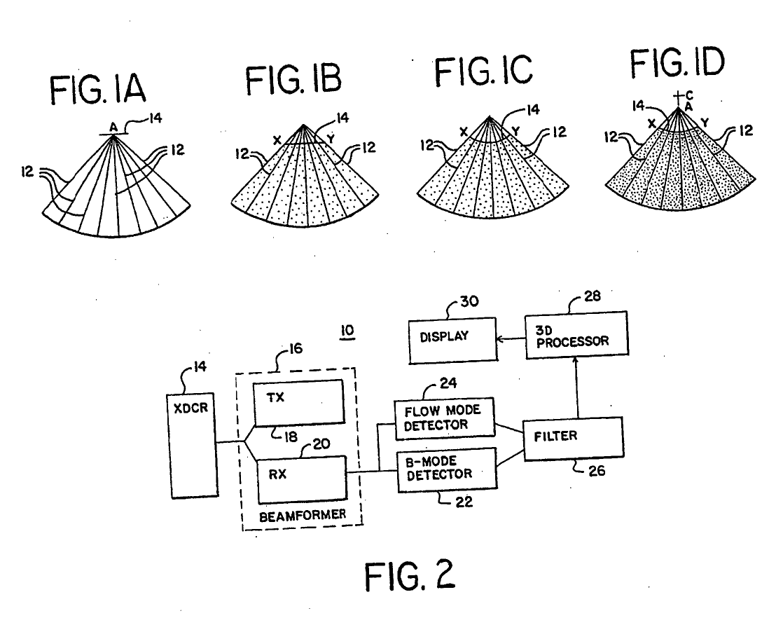

FIG. 2 shows one embodiment of a system 10 for scanning a three dimensional volume. The system 10 includes a transducer 14, beamformer 16, B-mode detector 22, flow mode detector 24, filter 26, three dimensional processor 28, and display 30. Additional, different or fewer components may be provided, such as providing the transducer 14 and beamformer 16 without additional components. As another example, only one detector 22, 24 is provided. The filter 26 is optional. As yet another example, a separate component is provided for scan converting or reconstructing the acquired data from a polar coordinate or acquisition format into a display or Cartesian coordinate format on a three dimensional grid. In one embodiment, the system 10 is a medical diagnostic ultrasound imaging system. Alternatively, a portion of the system 10 is a medical diagnostic ultrasound imaging system and the remainder of the system, such as the three dimensional processor 28 and display 30 are a workstation or computer.

The transducer array 14 is a multi dimensional array of transducer elements, such as piezoelectric or microelectromechanical elements. The elements of the array 14 are distributed in a multi-dimensional pattern. For example, a rectangular grid is provided for a two dimensional transducer array of elements. The rectangular grid may correspond to a square, rectangular or irregular outer shape. The elements have the same dimension, but may vary in sizes along one or more dimensions. An AxB arrangement of elements are provided were both A and B are greater than 1, such as being greater than 5. Any number of elements may be provided, such as a 9×9, 10×15, or larger array. A random, non-rectangular, ellipsoidal, sparse or other grid pattern or distribution of elements may be used.

The array 14 is a planer, such as having a flat surface for transmitting and receiving acoustic energy. Alternatively, the array 14 is a curved array or has a curved surface along an azimuth, elevation or both azimuth and elevation dimensions. Any arbitrary, irregular or regular surface formed by the face of the transducer defines the array geometry.

The aspect ratio of the multi-dimensional array 14 along the azimuth and elevation dimensions is one or not equal to one. For example, a greater azimuth extent is provided than elevation extent in response to a different number or size of elements along each dimension. Hexagonal, triangular or other distribution patterns of elements for the multi dimensional transducer array 14 may be used.

The beamformer 16 is a transmit beamformer 18 and receive beamformer 20. Alternatively, the beamformer 16 is a transmit beamformer 18 alone or a receive beamformer 20 alone. The transmit beamformer 18 includes a plurality of pulsers or waveform generators, delays, amplifiers and/or other components for generating transmit wave forms for different ones of the elements of the array 14. The receive beamformer 20 includes delays, amplifiers, one or more summers and/or other components for generating data representing one or more scan lines from acoustic energy received by the transducer array 14.

The transmit beamformer 18, the receive beamformer 20 or both are operable to form beams with ultrasound energy along a plurality of scan lines distributed within the three dimensional volume. The wave forms are relatively apodized and delayed for focusing generated acoustic energy along one or more scan lines during a transmit event. By applying relative apodization and delays across a plurality of channels or associated elements of the transducer array 14, the received information is beamformed. The beamformer 16 implements the scan geometry 34 and corresponding ultrasound scan lines from a look up table. The look up table defines the apodization and delay profile for each of the scan lines. Alternatively, or additionally, the beamformer 16 is operable to calculate, such as through interpolation, one or more of the scan lines and associated delay and apodization profiles. Ultrasound lines may be generated from different origins or positions along the transducer array 14. A line origin for each scan line is the point at which the first sample is collected along the ultrasound line or the location of intersection of the ultrasound line with the transducer array 14. The array geometry defines or provides for the line origins of the plurality of scan lines generated sequentially or simultaneously by the transmit and/or receive beamformers 18, 20.

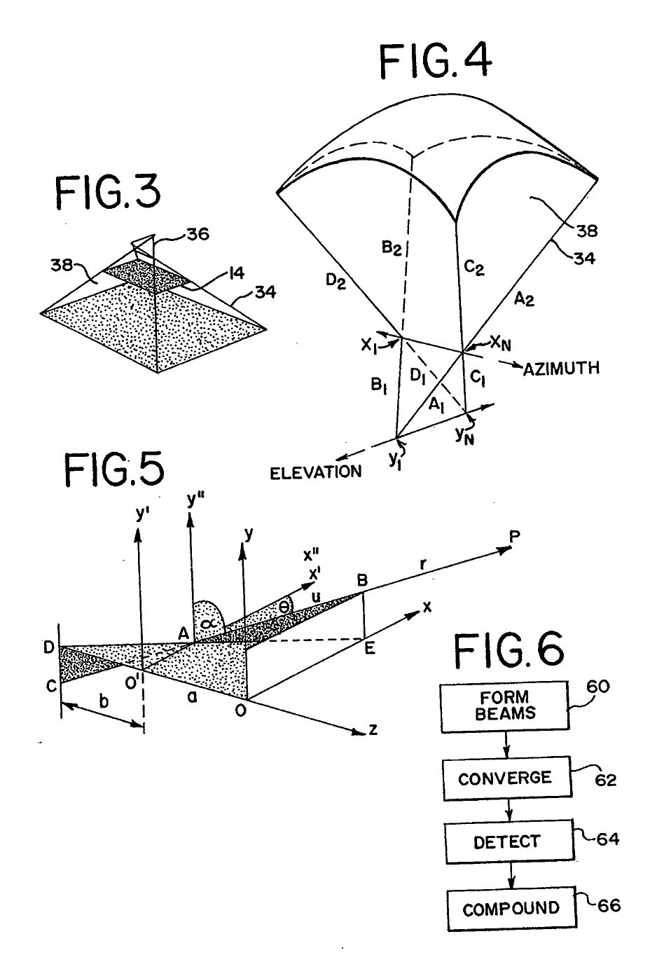

In response to the beamformer 16, the two dimensional transducer array 14 transmits and receives acoustic energy in a scan geometry for three dimensional imaging. The scan geometry includes a plurality of scan lines distributed within the three dimensional volume. FIG. 3 shows one embodiment of a graphical representation of the outer extent of the scan geometry 34. The plurality of scan lines are distributed along azimuth and elevation dimensions relative to the transducer 14 for scanning the region 38 below the transducer 14. As represented by the wire frame 36 above the transducer 14, the scan lines for scanning within the scan geometry 34 include a plurality of apexes. At most, fewer than all of the scan lines converge at a single apex. While shown as having different apexes behind the transducer 14, one or all of the apexes may be positioned on the face of the transducer 14 or in other positions relative to the transducer 14.

Two or more subsets of the scan lines intersect at two or more different locations, respectively, relative to the transducer array 14. For example, one subset of scan lines converges at one location or apex, and a different subset of scan lines converges at a different location or apex. The scan lines in each of the subsets are exclusive to the subsets, but none, some or all of the scan lines may converge at multiple apexes. The subsets may include one or more scan lines in common while having at least one different scan line.

The distribution of the two or more apexes may have any pattern in three dimensional space. Any number of apexes may be provided within the pattern. In one embodiment, two different distributions of apexes are provided. A given ultrasound line passes through both distributions of apexes. The distribution may include three dimensional surfaces, planes, lines, points, clouds or volumes. Alternatively, a single distribution is provided with a plurality of different apexes with or without scan lines having two or more apexes. Ultrasound scan lines are fired from any point in the distribution along any direction of choice.

FIG. 4 shows one embodiment using two different distributions of apexes for a scan geometry 34 to scan a volume or scan region 38. The apexes are distributed along the elevationally spaced line Y₁ through Y_{N} and along the azimuthally spaced line X₁ through X_{N}, where N is the number of apexes along the line. N along azimuth may be equal to or different than the N value along elevation. As shown in FIG. 4, the two lines X₁X_{N} and Y₁Y_{N} are orthogonal to each other and spaced apart along a range dimension. In alternative embodiments, the two lines X₁X_{N} and Y₁Y_{N} are non-orthogonal to each other within the azimuth-elevation space.

The outer extremity scan lines A, B, C and D are shown in FIG. 4. Other scan lines are provided within the scan volume 38 and associated scan geometry 34. The intersections or apexes of the scan lines are distributed along the two lines X₁X_{N} and Y₁Y_{N}. Along a given plane within the scan geometry 34, a plurality of scan lines are provided. For example, an outer extremity plane defined by the scan lines A and C includes a plurality of scan lines at different angles originating from the elevation line Y₁Y_{N} and passing through the azimuthal line X₁X_{N} at X_{N}. All of the scan lines on that surface include the same apex X_{N}. The scan lines each intersect with different apex positions Y₁ through Y_{N} on the elevation line Y₁, Y_{N}. Other azimuthally spaced planes within the scan geometry 34 interior of the outer extremities can be formed by using a plurality of scan lines originating from various apex locations along the elevation line Y₁Y_{N} and each passing through a different X apex on the azimuthal line X₁X_{N}. A plurality of different planes is provided between the planes formed by CA and DB. The plane defined by DB includes a plurality of scan lines with a common apex at X₁. The continuous volume inside the outer extremities defines the space of all possible ultrasound lines. Only a subset of those ultrasound lines is fired into the body using various different schemes available for sampling the ultrasound line space.

Along the elevation dimension, a plurality of different planes is provided from BA to CD. The plane BA includes a plurality of scan lines with a common apex at Y₁ but different intersections along the azimuthal line X₁X_{N}. Similarly, the plane defined by the scan lines CD include scan lines with a common apex at Y_{N} where the scan lines pass through different locations along the X₁X_{N} azimuth line.

The scan geometry 34 shown in FIG. 4 is a Vector® scan geometry for scanning a three dimensional volume. The apex distributions are provided along two straight lines. Since the apex geometry is independent of the scan geometry, the apex geometry may also be used for sector, curved linear and curved-vector scan formats. For example, the apex distributions may collapse into one point or a single apex. The line origins are also located at the one point, providing a sector scan geometry. For Vector® scan geometry, the apex distributions reduce to a pair of straight lines X₁X_{N} and Y₁Y_{N} which may or may not intersect. The line origins are located at a plane or surface corresponding to the array 14 spaced away from the apex lines X₁X_{N} and Y₁Y_{N}. The line origin surface may be parallel to both apex lines or intersect with one or both lines. For a curved scan geometry, the two dimensional transducer 14 provides for line origins along a curved surface, such as sphere, cylinder, an ellipsoid, parabloid, hyperboloid, superquadratic, curve linear, or non-curve linear surface. The surface intersects or is free of intersection with one or more of the apex distributions within the scan geometry. For a linear scan geometry, the scan lines are parallel. Any single one or combination of different scan line patterns may be used for scanning an entire volume or scan region 38.

In the embodiments shown in FIGS. 3 and 4, each ultrasound line passes through two distributions of apexes. In alternative embodiments, two or more apexes are provided within the scan geometry where one, some or all of the ultrasound scan lines pass through only a single apex or apex distribution. Two or more apexes for the ultrasound scan lines with or without each scan line passing through the two or more of the apex distributions is provided in other embodiments. The aspect ratio of the azimuth and elevation dimensions of the transducer array may vary. For example, the aspect ratio is one or not equal to one. By providing for multiple apexes, different volumes and volume shapes may be scanned or provided in a scan region 38.

FIG. 5 shows one embodiment of the angular relationship of a Vector® scan with different azimuthal and elevational apexes shown in FIG. 4. The ultrasound line BP is fired into the body from a 2D array located in the (x, y) plane. The azimuthal apices are located in the line CD while the elevational apices are located in the line O′A. Let the azimuthal apex length, OD, be ‘a+b’ and the elevational apex length, OO′ be ‘a’.

Then:
x=(z+a+b)ρ cos θ
y=(z+a)ρ cos α
z=r/p,
where,
ρ=sqrt(1+y²/(z+a)²+x²/(z+a+b)²)

In the case shown in FIG. 4, a=0.5, b=0.5 and maximum range=1.0. The scan lines intersect both the azimuthal apex line and the elevational apex line, which are orthogonal to each other, but never intersect. This scan geometry case may be useful when the 2D array 14 is a rectangular in shape, and the elevational and azimuthal field of views is to be identical. For example, supposing the azimuthal width of the array is twice the elevational width, but a 45 degree field of view is desired in both azimuth and elevation. The elevational apex line is moved to halfway between the array and the azimuthal apex line.

The scan geometry corresponds to a single scan of a three dimensional volume. The plurality of scan lines are distributed within the three dimensional volume pursuant to the scan geometry. For sequential scans of the same volume, the same scan geometry or a different scan geometry is provided.

Referring to FIG. 2, the output beamformed data corresponding to the scan geometry is provided to one or two of the detectors 22, 24. The B-mode detector 22 is operable to determine the intensity, power or energy associated with the data along the scan lines. The flow mode detector 24 is a doppler, correlation or other detector for determining relative motion (e.g. velocity, energy, power and/or variance) along the scan lines. The data provided to each of the detectors may be associated with sequential scans using different scan geometries. For example, a smaller volume, less dense scan line distribution, or a differently shaped volume is scanned for flow mode detection than for B-mode detection. The different scan geometries may include one scan geometry with a single apex or both scan geometries with two or more apexes. Other modes of operation and associated detectors, such as harmonic, using a same or different scan geometries may be provided.

The filter 26 is a digital signal processor, processor, digital filter, analog filter, video filter, finite impulse response filter, infinite impulse response filter or other now known or later developed filter. The filter is positioned after the detectors 22, 24 for filtering data without phase information or positioned prior to the detectors 22, 24 for filtering complex coefficients. The filter 26 is operable to compound or synthesize data from the beamformer 16. Data associated with two different scans of the three dimensional volume is averaged or weighted and averaged. The different scans are associated with different distributions of scan lines. The spatial variation of the ultrasound scan lines or scan geometries for the sequential scans results in de-correlated speckle information. Compounding reduces speckle content. Different imaging frequencies and/or filters may alternatively or additionally be used for different scans and compounding to reduce speckle. Detected data is compounded or data prior to detection is synthesized. In alternative embodiments, the filter 26 is skipped or provides for temporal or spatial filtering without using different scan geometries.

The three dimensional processor 28 converts data to a display format or other format for rendering. The three dimensional processor 28 renders the three dimensional data into a two dimensional representation of the volume. Alternatively, the three dimensional processor 28 generates a two dimensional image representing an arbitrarily positioned plane through the scanned volume. The generated image is provided to the display 30.

In another embodiment using different scan geometries for sequential operation, the transmit beamformer 18 uses a first scan geometry or distribution of scan lines and the receive beamformer 20 uses a different scan geometry or distribution of scan lines. Transmit beamformer 18 uses the first scan geometry for transmission of acoustic energy. In response to the transmission, the receive beamformer 20 receives information using the different scan geometry within the same three dimensional volume. The data output by the receive beamformer 20 is responsive to both scan geometries. For example, a single-apex scan geometry is used for transmit and a different single or multiple apex scan geometry is used for receive. As another example, the data is responsive to a steered linear scan geometry for transmit while the scan geometry for reception is a linear or unsteered geometry. In some image forming techniques, some or all of the ultrasound lines displayed are formed by pre-detection summation or synthesis of multiple co-linear receive beams. Each of the receive beams is formed in response to a transmit event with a different steering angle. For spatial compounding or synthesizing, the same received geometry, such as a linear unsteered scan geometry may be used for received beams, but different linear steered geometries are provided for transmit. For example, three different scan geometries are sequentially provided on transmit, such as steered at a first angle, unsteered and steered at a negative of a first angle. The three different data sets are then compounded or synthesized.

FIG. 6 shows one embodiment of a method for scanning a three dimensional volume with ultrasound energy. The system 10 of FIG. 2 or a different system is used to implement the method of FIG. 6. Additional, different or fewer acts may be provided, such as providing acts 60 and 62 with or without act 64, act 66 or both acts 64 and 66.

In act 60, ultrasound beams are formed along a plurality, N, of scan lines within a three dimensional volume with a multidimensional transducer array for a single scan of the volume. Relative delays, apodization or other beamforming techniques are used to sequentially, simultaneously or both sequentially and simultaneously generate beams of ultrasound energy along one or more of the scan lines. The volume may be scanned multiple times using interleaving. For example, line-by-line, groups-of-lines or frame-by-frame interleaving is provided. For line-by-line or interleaving by groups-of-lines, one or more scanned lines may be used multiple times before a given scan for a single frame of data is acquired. Similarly, flow, doppler, harmonic or other scanning processes may provide for multiple transmissions and receptions along a same or adjacent scan lines for generating a single frame of data associated with a single scan of the three dimensional volume. The formed ultrasound beams are of predetected or detected data along each of the scan lines. The scan lines define the scan geometry for the single frame of data representing the three dimensional volume.

In act 62, the N scan lines converge at different locations, and at most N−1 of the scan lines converge at a single location. The convergence of act 62 occurs as a function of the scan geometry used for forming the beams in act 60. The converging scan lines intersect in two or more apexes. Different subsets of scan lines intersect or converge at different apexes. For example, two or more patterns or distributions of apexes are provided. In the embodiment shown in FIG. 4 above, the different subsets of scan lines converge along two different lines associated with different apexes. Each scan line passes through two apexes, but one, more or all of the scan lines may be passed through a single, three or more apexes.

In one embodiment, the formation of the beams of act 60 and associated convergence of act 62 are performed for a transmit operation. The beams are formed in act 60 using the convergence of act 62 for subsequent receive operation. The receive operation uses the same or different scan geometry then for the transmit operation. The act 60 and 62 are repeated for reception. The transmit and reception operations may be repeated for continuance or real-time three dimensional imaging.

In act 64, the ultrasound data received in response to acts 60 and 62 is detected. B-mode, doppler, flow mode, harmonic mode or other modes may be used for detecting the data. In one embodiment, the data is detected in different imaging modes. For example, acts 60 and 62 are performed for B-mode imaging. A different scan geometry with or without the convergence of act 62 is used for a different imaging mode, such as a doppler or flow mode. Alternatively, the same scan geometry is used for the different imaging mode. An image representing both modes is then generated.

In act 66, spatial compounding or synthesizing is provided. Acts 60 and 62 are repeated using different scan geometries, such as using different steering angles or moving one or more apexes relative to other apexes for the scan geometry. Data responsive to the different scans and associated scan geometries is compounded or synthesized. The combined data represents the three dimensional volume and is used for imaging or other processes.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I(we) claim:

1. In a scan geometry for three-dimensional ultrasound with a two-dimensional transducer array, the scan geometry including a plurality, N, of scan lines distributed in a three-dimensional volume, an improvement comprising:
at most N−1 scan lines converging at a single apex.

2. The improvement of claim 1 wherein a first sub-set of the N scan lines converge at a first apex and a second sub-set of the N scan lines converge at a second apex different than the first apex, the scan lines of the first sub-set exclusive from the scan lines of the second sub-set.

3. The improvement of claim 1 wherein an aspect ratio of the transducer array along the azimuth and elevation dimensions is not equal to one.

4. The improvement of claim 1 wherein the N scan lines converge to at least two apexes, the at least two apexes located on a first side of the two-dimensional transducer and a scanning region located on a second side opposite the first side.

5. The improvement of claim 1 wherein the two-dimensional transducer comprises a flat planar transducer with A×B elements where both A and B are greater than one.

6. The improvement of claim 1 wherein the two-dimensional transducer comprises a curved surface with A×B elements where both A and B are greater than one.

7. The improvement of claim 1 wherein the two-dimensional transducer comprises A×B elements where both A and B are greater than one and unequal.

8. The improvement of claim 1 wherein the N scan lines converge at first and second apex distributions, the first and second apex distributions each being a surface, a line or a point, at least one of the first and second apex distributions being other than the point.

9. The improvement of claim 8 wherein the first and second apex distributions are first and second lines, respectively.

10. The improvement of claim 9 wherein the first line is orthogonal to the second line.

11. The improvement of claim 1 further comprising a different scan geometry of scan lines distributed in the three-dimensional volume with at least two different apexes, wherein data responsive to the scan geometry and the different scan geometry are spatially compounded or synthesized.

12. The improvement of claim 1 further comprising a different scan geometry of scan lines distributed in the three-dimensional volume with at least two different apexes, wherein B-mode imaging is responsive to the scan geometry and flow imaging is response to the different scan geometry.

13. The improvement of claim 1 further comprising a different scan geometry of scan lines distributed in the three-dimensional volume with at least two different apexes, wherein the scan geometry is used for transmission of ultrasound energy and the different scan geometry is used for reception of ultrasound energy.

14. A system for scanning a three-dimensional volume, the system comprising:
a multi-dimensional array of transducer elements;
a beamformer connectable with the multi-dimensional array, the beamformer operable to form beams with ultrasound energy along a plurality of scan lines distributed within the three-dimensional volume, two or more sub-sets of the scan lines intersecting at two or more locations, respectively, relative to the array.

15. The system of claim 14 wherein a first sub-set of the two or more sub-sets of scan lines converge at a first location of the two or more locations and a second sub-set of the two or more sub-sets of scan lines converge at a second location of the two or more locations, the second location different than the first location, the scan lines of the first sub-set exclusive from the scan lines of the second sub-set.

16. The system of claim 14 wherein a first aspect ratio of the multi-dimensional array along the azimuth and elevation dimensions is not equal to one and a second aspect ratio of the plurality of scan lines along the azimuth and elevation dimensions is equal to one.

17. The system of claim 14 wherein the multi-dimensional array comprises a planar or a curved array.

18. The system of claim 14 wherein the multi-dimensional array comprises A×B elements where both A and B are greater than five.

19. The system of claim 14 wherein intersections of the scan lines are distributed in first and second distribution patterns, the first and second distribution patterns each being a surface, a line or a point, at least one of the first and second distribution patterns being other than the point, a first location of the two or more locations being in the first distribution pattern and a second location of the two or more locations being in the second distribution pattern.

20. The system of claim 19 wherein the first and second distribution patterns are first and second lines, respectively.

21. The system of claim 20 wherein the first line is orthogonal to the second line.

22. The system of claim 14 wherein the plurality of scan lines distributed within the three-dimensional volume correspond to a scan geometry for a single scan of the three-dimensional volume.

23. The system of claim 22 further comprising:
a filter operable to compound or synthesize data from the beamformer, the data responsive to different scans of the three-dimensional volume with different distributions of scan lines.

24. The system of claim 22 further comprising:
a B-mode detector responsive to data from a first scan of the three-dimensional volume with a first distribution of scan lines; and
a flow mode detector responsive to data from a second scan of the three-dimensional volume with a second distribution of scan lines, the second distribution different than the first distribution.

25. The system of claim 22 wherein the beamformer comprises:
a transmit beamformer operable to perform a first scan of the three-dimensional volume with a first distribution of scan lines;
a receive beamformer operable to perform a second scan of the three-dimensional volume with a second distribution of scan lines, the second distribution different than the first distribution, data output by the receive beamformer responsive to the second distribution and acoustic energy transmitted by the transmit beamformer in the first distribution.

26. A method for scanning a three-dimensional volume with ultrasound energy, the method comprising:
(a) forming ultrasound beams along a plurality, N, of scan lines within the three-dimensional volume with a multi-dimensional transducer array for a single scan of the three-dimensional volume; and
(b) converging the N scan lines at different locations and at most N−1 of the scan lines at a single location.

27. The method of claim 26 wherein (b) comprises converging the N scan lines at first and second apexes.

28. The method of claim 26 wherein (a) comprises forming the ultrasound beams along the plurality of scan lines defining a scan geometry for a single frame of data representing the three-dimensional volume.

29. The method of claim 26 wherein (b) comprises converging different sub-sets of the scan lines at different distributions of apexes.

30. The method of claim 29 wherein (b) comprises converging the different sub-sets of the scan lines along a first line associated with a first plurality of the apexes and along a second line associated with a second plurality of the apexes.

31. The method of claim 26 further comprising:
(c) spatially compounding or synthesizing data responsive to (a) with data responsive to a different scan of the three-dimensional volume.

32. The method of claim 26 further comprising:
(c) performing (a) and (b) for a first imaging mode; and
(d) scanning with a different geometry for a second imaging mode different than the first imaging mode.

33. The method of claim 26 further comprising:
(c) performing (a) and (b) for transmit operation; and
(d) repeating (a) and (b) with a different scan geometry for receive operation responsive to the transmit operation.

34. The improvement of claim 11 wherein data responsive to the scan geometry is associated with a different imaging frequency than the data responsive to the different scan geometry.

35. The system of claim 23 wherein the data responsive to different scans of the three-dimensional volume is responsive to different frequencies.

36. The method of claim 31 wherein (c) comprises compounding data associated with different frequencies.

37. A method for scanning a three-dimensional volume with ultrasound energy, the method comprising:
(a) transmitting ultrasound beams along a first plurality of scan lines within the three-dimensional volume with a multi-dimensional transducer array for a single scan of the three-dimensional volume, the first plurality of scan lines converging at a first apex; and
(b) receiving ultrasound beams in response to (a) along a second plurality of scan lines within the three-dimensional volume with the multi-dimensional transducer array for the single scan of the three-dimensional volume, the second plurality of scan lines converging at a second apex different than the first apex.

38. The method of claim 37 wherein the first apex is an only apex for a transmit portion of the single scan and the second apex is an only apex for a receive portion of the single scan.
